(19) United States
(12) Patent Application Publication
(10) Pub. No.: US 2025/0151139 A1
(43) Pub. Date: May 8, 2025

(54) RESOURCE REQUEST FOR PEER-TO-PEER COMMUNICATIONS

(71) Applicant: Samsung Electronics Co., Ltd., Suwon-si (KR)

(72) Inventors: Rubayet Shafin, Allen, TX (US); Yue Qi, Plano, TX (US); Boon Loong Ng, Plano, TX (US); Peshal Nayak, Plano, TX (US); Vishnu Vardhan Ratnam, Plano, TX (US); Elliot Jen, Taipei City (TW)

(21) Appl. No.: 18/927,751

(22) Filed: Oct. 25, 2024

Related U.S. Application Data
(60) Provisional application No. 63/547,744, filed on Nov. 8, 2023.
(60) Provisional application No. 63/547,938, filed on Nov. 9, 2023.

(51) Int. Cl. H04W 76/14; H04W 28/02; H04W 74/0816

(52) U.S. Cl. CPC H04W 76/14; H04W 74/0816; H04W 28/0278

(57) ABSTRACT

A station (STA) in a wireless network comprising a memory and a processor coupled to the memory, the processor configured to establish a peer-to-peer (P2P) link with a peer STA; transmit, to an access point (AP), a request frame that requests a resource from the AP to perform P2P communication with the peer STA; receive, from the AP, a trigger frame that allocates a transmission opportunity (TXOP) to the STA; and transmit, to the peer STA, one or more frames via the P2P link within the TXOP.

### CROSS-REFERENCE TO RELATED APPLICATION(S)

This application claims the benefit of priority from U.S. Provisional Application No. 63/547,744, entitled “RESOURCE REQUEST FOR PEER-TO-PEER COMMUNICATION” filed Nov. 8, 2023, and U.S. Provisional Application No. 63/547,938, entitled “RESOURCE REQUEST FOR PEER-TO-PEER COMMUNICATION” filed Nov. 9, 2023, all of which are incorporated herein by reference in their entireties.

### TECHNICAL FIELD

This disclosure relates generally to a wireless communication system, and more particularly to, for example, but not limited to, resource request for peer-to-peer (P2P) communications.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, comprising: a memory; and a processor coupled to the memory. The processor is configured to establish a peer-to-peer (P2P) link with a peer STA. The processor is configured to transmit, to an access point (AP), a request frame that requests a resource from the AP to perform P2P communication with the peer STA. The processor is configured to receive, from the AP, a trigger frame that allocates a transmission opportunity (TXOP) to the STA. The processor is configured to transmit, to the peer STA, one or more frames via the P2P link within the TXOP.

In some embodiments, the resource is a TXOP.

In some embodiments, the processor is further configured to receive a response frame from the AP that accepts the request for resource or provides an alternative resource.

In some embodiments, the request frame includes at least one or more information from: a time requested by the STA on the P2P link for P2P communication; a traffic identifier for P2P communication for the requested time; a bandwidth for the P2P link for the request time; or a link identifier that identifies the P2P link.

In some embodiments, the trigger frame allocates a portion of an obtained TXOP of the AP to the STA

In some embodiments, the processor is further configured to receive capabilities information from the AP that indicates a capability to support resource sharing.

In some embodiments, the request frame includes a buffer status report indicating pending traffic for uplink or the P2P link.

In some embodiments, the request frame includes a quality of service (QOS) characteristics element that includes a traffic identifier for P2P communication.

One aspect of the present disclosure provides an access point (AP) in a wireless network, comprising: a memory; and a processor coupled to the memory. The processor is configured to receive, from a station (STA), a request frame that requests a resource from the AP to perform P2P communication with a peer STA. The processor is configured to transmit, to the STA, a trigger frame that allocates a transmission opportunity (TXOP) to the STA.

In some embodiments, the resource is a TXOP.

In some embodiments, the processor is further configured to transmit a response frame to the STA that accepts the request for resource or provides an alternative resource.

In some embodiments, the request frame includes at least one or more information from: a time requested by the STA on the P2P link for P2P communication; a traffic identifier for P2P communication for the requested time; a bandwidth for the P2P link for the request time; or a link identifier that identifies the P2P link.

In some embodiments, the trigger frame allocates a portion of an obtained TXOP of the AP to the STA.

In some embodiments, the processor is further configured to transmit capabilities information to the STA that indicates a capability to support resource sharing.

In some embodiments, the request frame includes a buffer status report indicating pending traffic for uplink or the P2P link.

In some embodiments, the request frame includes a quality of service (QOS) characteristics element that includes a traffic identifier for P2P communication.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIGS. 5A to 5C show an example of a MAC frame format in WLAN systems.

FIG. 6 illustrates a format of a P2P Resource Request element in accordance with an embodiment.

FIG. 7 illustrates a format of a P2P Request field in accordance with an embodiment.

FIG. 8 illustrates a TXOP request-response process for P2P transmission in accordance with an embodiment.

FIG. 9A shows an example of a QoS characteristic element in accordance with an embodiment.

FIG. 9B shows an example of a Control Info field within the QoS characteristic element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

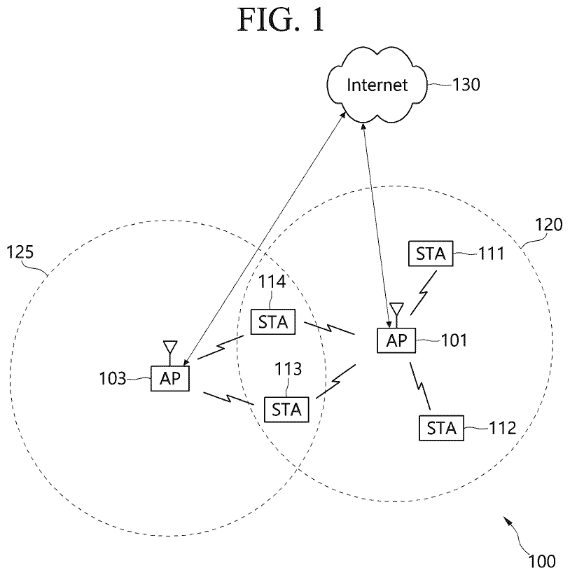

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage area 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

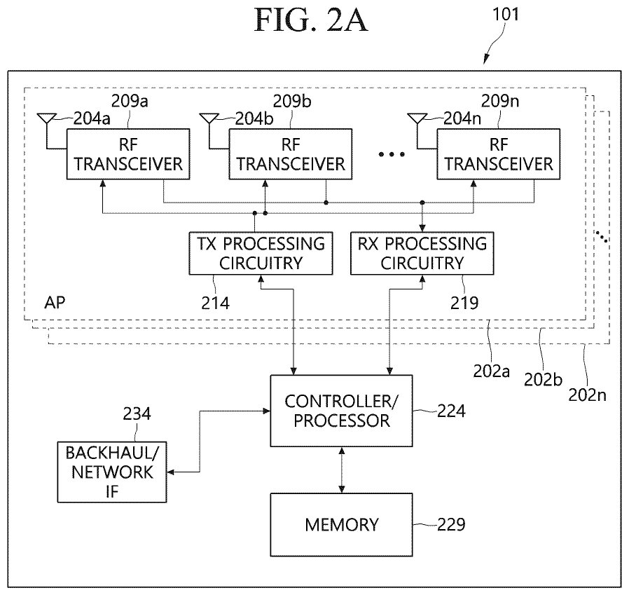

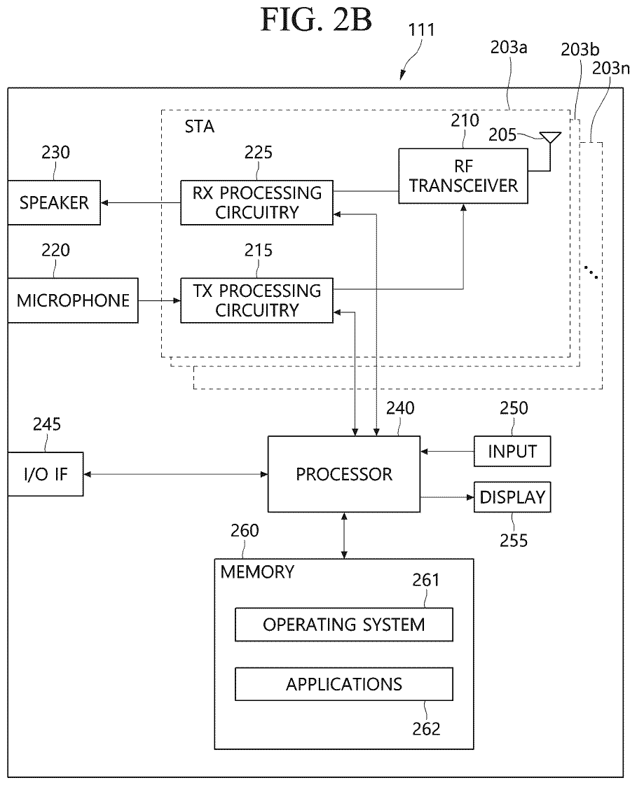

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

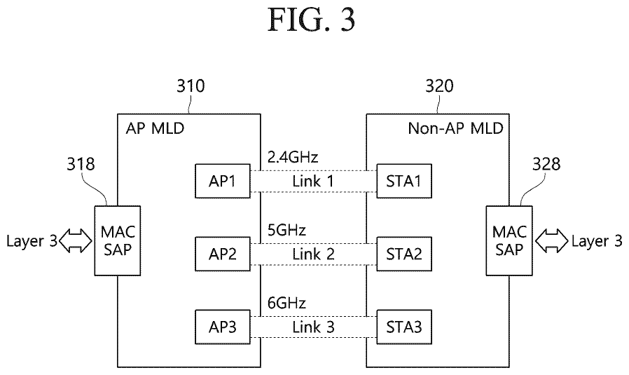

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D4.0, “Wireless LAN Medium Access Control (MAC) and Physical Layer (PHY) Specifications.”

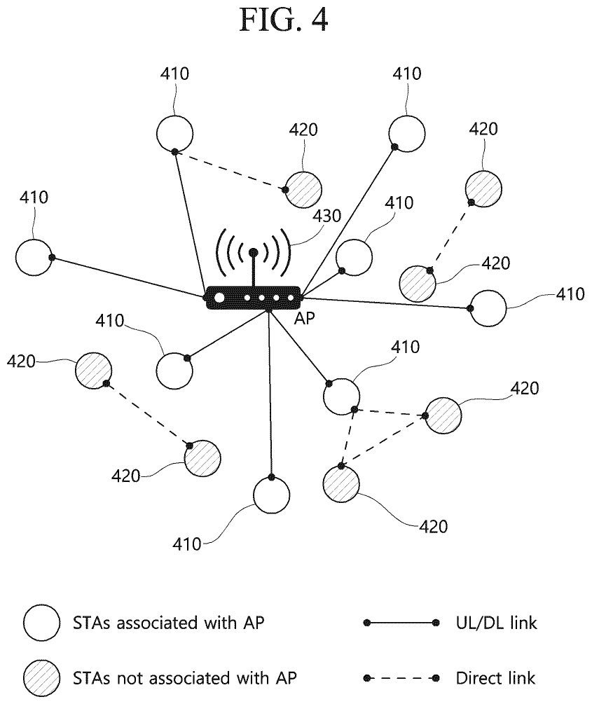

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 are non-AP STAs associated with AP 430, and a plurality of STAs 420 are non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network. Many of these devices may have a tolerance for latency, but still compete with the devices running low-latency applications for the same time and frequency resources. In some cases, the AP as a network controller may not have enough control over the unregulated or unmanaged traffic that contends with the low-latency traffic within the infrastructure basic service set (BSS). In some embodiments, the infrastructure BSS is a basic service set that includes an AP and one or more non-AP STAs, while the independent BSS is a basic service set where non-AP STAs communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle unmanaged traffic while prioritizing low-latency traffic in the network.

In the conventional WLAN system, a non-AP STA may inform an associated AP about its buffer status in two ways. First, the non-AP STA may include a Queue Size subfield in the QoS Control field of any QoS Data or QoS Null frames that the non-AP STA transmits to the associated AP. Second, the non-AP STA may include a buffer status report (BSR) Control subfield in the A (aggregated)-Control field of the HT (high-throughput) Control field of any QoS (Quality of Service) Data or QoS Null frames that the non-AP STA transmits to the associated AP.

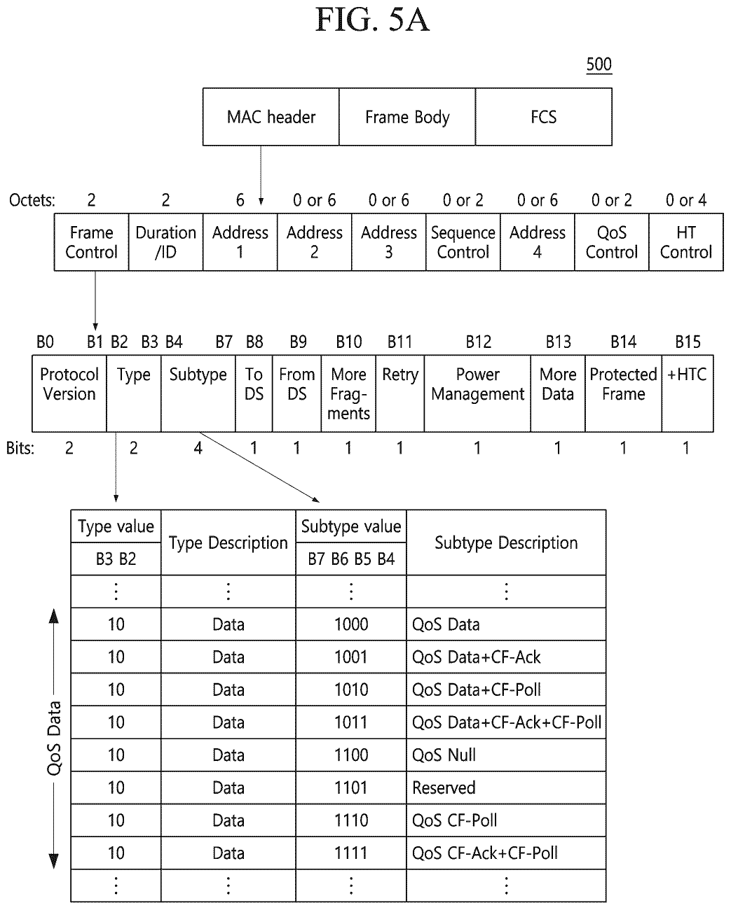

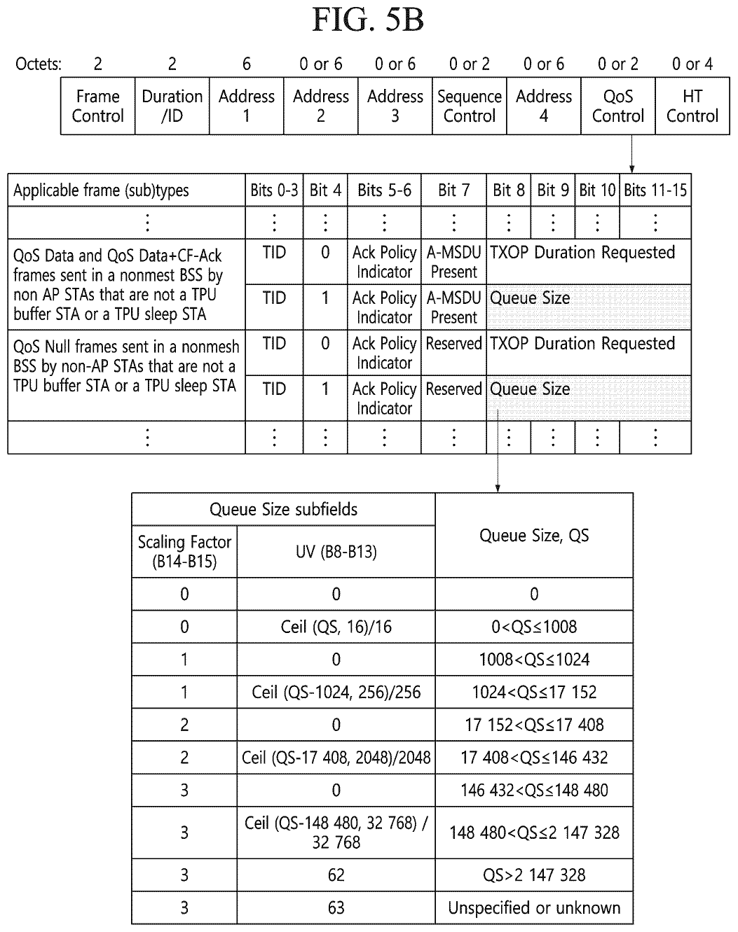

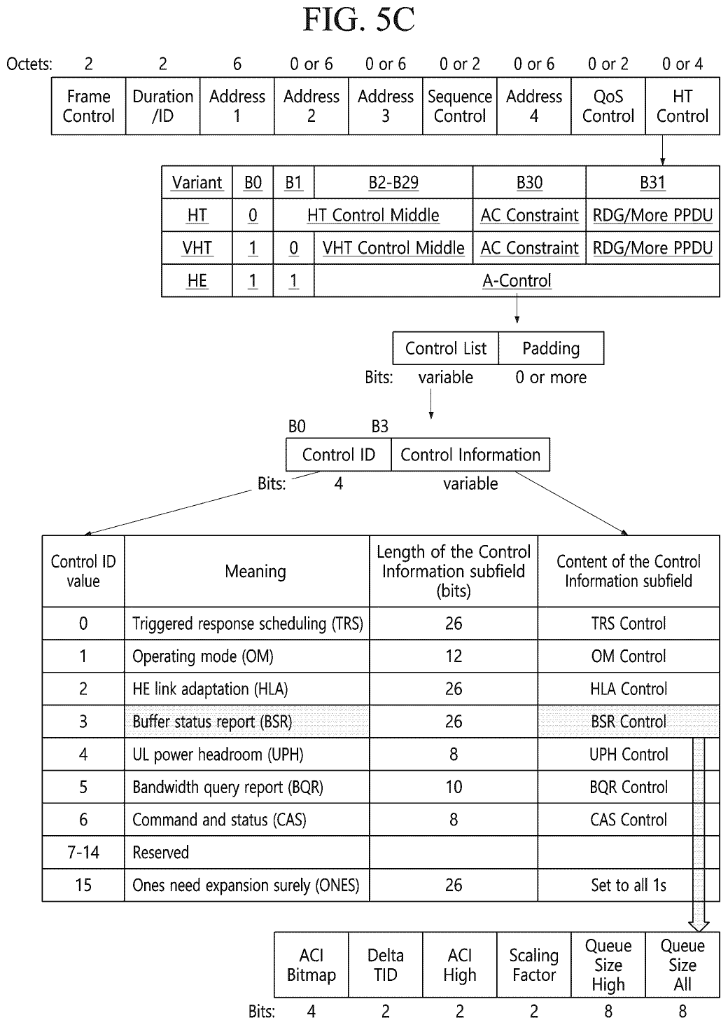

FIGS. 5A to 5C show an example of a MAC frame format 500 in WLAN systems.

Referring to FIG. 5A, the MAC frame format 500 includes a MAC header, a Frame Body, and a frame check sequence (FCS) field. The MAC header includes a Frame Control field, a Duration/ID field, an Address 1 field, an Address 2 field, an Address 3 field, a Sequence Control field, an Address 4 field, a QoS Control field, and a HT Control field. The Frame Control field includes a Protocol Version subfield, a Type subfield, a Subtype subfield, a To DS (Distribution System) subfield, a From DS subfield, a More Fragments subfield, a Retry subfield, a Power Management subfield, a More Data subfield, and a Protected Frame subfield, and a +HTC subfield.

As shown in FIG. 5A, the Type subfield and Subtype subfield together identify the function of the frame. There are three frame types: control frame, data frame, management frame. For example, when the type value indicated by the Type subfield (B3 and B2) is ‘10,’ it is defined as the data frame. In addition, the most significant bit (MSB) (B7) of Subtype subfield is defined as the QoS field. The table in FIG. 5 shows examples of QoS data frames.

FIG. 5B shows an example of Queue Size subfields in WLAN systems. Referring to FIG. 5B, the QoS Control field in the MAC header field of the MAC frame 500 indicates the traffic category (TC) or the traffic stream (TS) to which the frame belongs as well as various other QoS related information about the frame that varies by frame type, subtype, and type of transmitting STA. For convenience of description, FIG. 5B illustrates only queue size related information. Referring to FIG. 5B, the QoS Control field may include a Queue Size subfield for certain types of frames. The Queue Size subfield indicates the amount of buffered traffic for a given TC or TS at the STA sending the frame. The AP receives information in the Queue Size subfield and uses it to determine the TXOP duration assigned to the STA or to determine the uplink (UL) resource assigned to the STA.

FIG. 5C shows an example of the BSR Control subfield in WLAN systems. Referring to FIG. 5C, the HT Control field in the MAC header field of the MAC frame 500 includes three variant: HT variant, VHT (very high throughput) variant, and HE (high efficiency) variant. The HE variant includes A-Control subfield, which includes a Control List subfield and padding bits. The Control List subfield includes one or more Control subfields. The format of each Control subfield includes a Control ID subfield and a Control Information subfield. The Control ID subfield indicates the type of information carried in the Control Information subfield. As illustrated in the table of FIG. 5C, the Control Information subfield may include various contents including the BSR Control subfield. The BSR Control subfield includes ACI Bitmap subfield, a Delta TID (traffic identifier) field, an ACI (access category index) High subfield, a Scaling Factor, a Queue Size High subfield, and a Queue Size All subfield.

In the conventional WLAN system, the buffer status report to the AP using either the Queue Size subfield or the BSR Control subfield is used to assist the AP in allocating UL MU (multi-user) resources. IEEE 802.11be standard provides a mechanism, known as a triggered TXOP sharing (TXS) (e.g., TXS Mode 2), that allows an AP to allocate a portion of its obtained TXOP to an associated non-AP STA for P2P communication. In the triggered TXOP sharing mode 1, the STA may transmit one or more non-trigger-based (non-TB) physical layer protocol data units (PPDUs) to the AP. In the TXOP sharing mode 2, the STA may transmit one or more PPDUs to the AP or to a peer STA for P2P communication.

However, the conventional WLAN system provides no mechanisms for the non-AP STA to request resources (e.g., TXOP) for P2P communication. Such mechanisms may be beneficial for an enhanced multi-device connectivity experience.

In some embodiments, a frame can be transmitted to request resources (e.g., TXOP) from an AP for P2P communications. In some embodiments, a P2P Resource Solicitation frame can be used to request TXOP from the AP for P2P communications. In some embodiments, the frame can be a Protected EHT Action frame as shown in Table 1 in accordance with an embodiment. As shown in Table 1, the value of “13” may indicate that the frame is a P2P Resource Solicitation frame.

TABLE 1

| Value | Meaning | Time priority |
|---|---|---|
| 0 | TID-To-Link Mapping Request | No |
| 1 | TID-To-Link Mapping Response | No |
| 2 | TID-To-Link Mapping Teardown | No |
| 3 | EPCS Priority Access Enable Request | No |
| 4 | EPCS Priority Access Enable Response | No |
| 5 | EPCS Priority Access Teardown | No |
| 6 | EML Operating Mode Notification | No |
| 7 | Link Recommendation | No |
| 8 | Multi-Link Operation Update Request | No |
| 9 | Multi-Link Operation Update Response | No |
| 10 | Link Reconfiguration Notify | No |
| 11 | Link Reconfiguration Request | No |
| 12 | Link Reconfiguration Response | No |
| 13 | P2P Resource Solicitation | No |
| 14-255 | Reserved | |

In some embodiments, the P2P Resource Solicitation frame is transmitted by an EHT non-AP STA to request for TXOP to its associated AP for peer-to-peer communication. The Action field of the P2P Resource Solicitation frame may include the information shown in Table 2 in accordance with an embodiment.

TABLE 2

| Order | Information |
|---|---|
| 1 | Category |
| 2 | Protected EHT Action |
| 3 | P2P Resource Request |

The Category field may provide information regarding a category of the frame.

The Protected EHT Action field may provide information to differentiate the Protected EHT Action frame formats.

The P2P Resource Request field may include information regarding a resource need for peer-to-peer communications.

In some embodiments, the P2P Resource Request can be added in the list of Elements used in the IEEE 802.11 standard, as shown in Table 3 below in accordance with an embodiment.

TABLE 3

| | | Element ID | | |
|---|---|---|---|---|
| Element | Element ID | Extension | Extensible | Fragmentable |
| P2P Resource | 255 | 136 | Yes | No |
| Request | | | | |

In some embodiments, the P2P Resource Request element may include a set of parameters that indicates a non-AP STA's resource need for peer-to-peer communication.

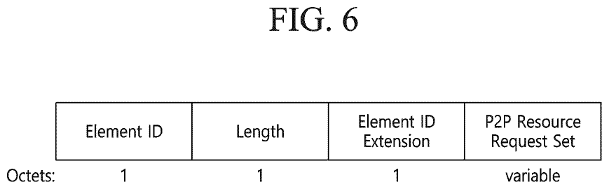

FIG. 6 illustrates a format of a P2P Resource Request element in accordance with an embodiment. The element may include an Element ID field, a Length field, and Element ID Extension field and a P2P Resource Request Set field.

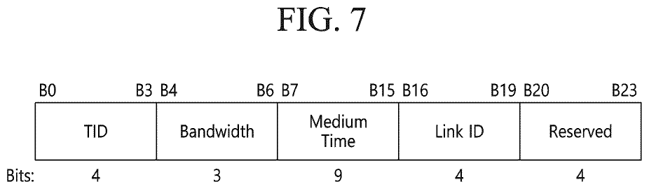

The Element ID field may provide an identifier for the element. The Length field may provide length information for the element. The Element ID Extension field may provide extension information for the element. The P2P Resource Request Set field may include one or more P2P Request fields, which is explained in detail with reference to FIG. 7.

FIG. 7 illustrates a format of a P2P Request field in accordance with an embodiment. The P2P Request field may include a TID field, a Bandwidth field, a Medium Time field, a Link ID field, and a Reserved field.

The TID field may indicate the TID for which medium time is requested for peer-to-peer communication.

The Bandwidth field may indicate the maximum bandwidth of the P2P link(s) for which medium time is requested on the link identified by the Link ID subfield. The encoding of the Bandwidth subfield is shown in Table 4 in accordance with an embodiment.

TABLE 4

| Bandwidth subfield value | Bandwidth |
|---|---|
| 0 | 20 MHz |
| 1 | 40 MHz |
| 2 | 80 MHz |
| 3 | 160 MHZ |
| 4 | 320 MHZ |
| 5-7 | Reserved |

The Medium Time field may include an unsigned integer that specifies the medium time, in units of 256 microseconds, requested by the STA on the link identified by the Link ID subfield for peer-to-peer communication.

The Link ID field may indicates the link on which medium time is requested.

In some embodiments, a non-AP STA with dot11EHTTXOPSharingTFOptionImplemented equal to true and that sets the Triggered TXOP Sharing Mode 2 Support subfield in the EHT Capabilities element to 1 may send a P2P Resource Solicitation frame to its associated AP. The P2P Resource Solicitation frame may indicate the non-AP STA's need for TXOP for peer-to-peer communication. In some embodiments, the non-AP STA may transmit the P2P Solicitation frame if the non-AP STA receives an EHT Capabilities element from the AP with the Triggered TXOP Sharing Mode 2 Support subfield set to 1. Upon receiving a P2P Resource Solicitation frame from the non-AP STA, the AP may allocate enough resources to the non-AP STA to satisfy the non-AP STA's P2P communication needs as identified by the P2P Resource Solicitation frame. In some embodiments, the AP can allocate the resources by allocating TXOP to that STA by sending MU request-to-send (RTS) TXS frame (Mode-2) that would allow P2P Communication using the TXOP.

In some embodiments, a non-AP EHT STA with dot11EHTTXOPSharingTFOptionImplemented equal to true that has successfully established a Stream Classification Service (SCS) stream with an EHT AP for a direct link as specified in a Quality of Service (QOS) Characteristics element included in the corresponding SCS Request frame. The non-AP EHT STA may send a buffer status report for a traffic identifier (TID) identified in the QoS Characteristics element. This buffer status report, when transmitted during the P2P service period characterized by the Minimum Service Interval and the Maximum Service Interval field values of the QoS Characteristics element, can account for both uplink and peer-to-peer traffic for the non-AP STA. The Minimum Service Interval field may indicate the minimum interval between the start of two consecutive service periods that are allocated to the STA for direct link frame exchanges when the Direction subfield is set to the direct link. The Maximum Service Interval field may indicate the maximum interval between the start of two consecutive service periods that are allocated to the STA for direct link frame exchanges when the Direction subfield is set to the direct link.

In some embodiments, the buffer status report, when transmitted outside the P2P service period characterized by the Minimum Service Interval and the Maximum Service Interval field values of the QoS Characteristics element, can account for uplink traffic for the non-AP STA. In some embodiments, the EHT AP, upon receiving the buffer status report from the non-AP STA that indicates a non-empty queue for the TID, may facilitate the transmission of the pending buffered units (BUs) over the direct link specified in the Link ID subfield of the QoS Characteristics element within the minimum and maximum service interval specified in the QoS Characteristics element.

In some embodiments, upon receiving the P2P Resource Solicitation frame from a non-AP STA, an AP can send an acknowledgment frame to the non-AP STA. In certain embodiments, upon receiving the P2P Resource Solicitation frame from a non-AP STA, the AP can send a response frame to the non-AP STA. In some embodiments, the response frame may indicate whether or not the AP accepts the TXOP request made by the non-AP STA. In certain embodiments, the response frame may suggest an alternative grant for TXOP with an alternative set of parameters. In some embodiments, the AP can use a P2P Resource Solicitation frame to indicate such a response to the non-AP STA. In certain embodiments, a frame, such as a P2P Resource Solicitation Response frame, can be used to indicate such a response by the AP to the non-AP STA. In some embodiments, the format of the P2P Resource Solicitation Response frame can be the same as or similar to the P2P Resource Solicitation frame.

In some embodiments, an AP may receive a P2P Resource Solicitation frame from a non-AP STA that indicates a request for TXOP from the AP. In some embodiments, if, subsequently, the AP accepts the requests and indicates the acceptance of the request from the non-AP STA in a response frame (e.g., in a P2P Resource Solicitation Response frame), the AP can allocate TXOP to the non-AP STA to satisfy the TXOP need indicated by the non-AP STA. In some embodiments, in order to allocate the TXOP, the AP can send an MU-RTS TXS trigger frame (mode-2) to facilitate the non-AP STA's P2P transmission using the TXOP received from the AP.

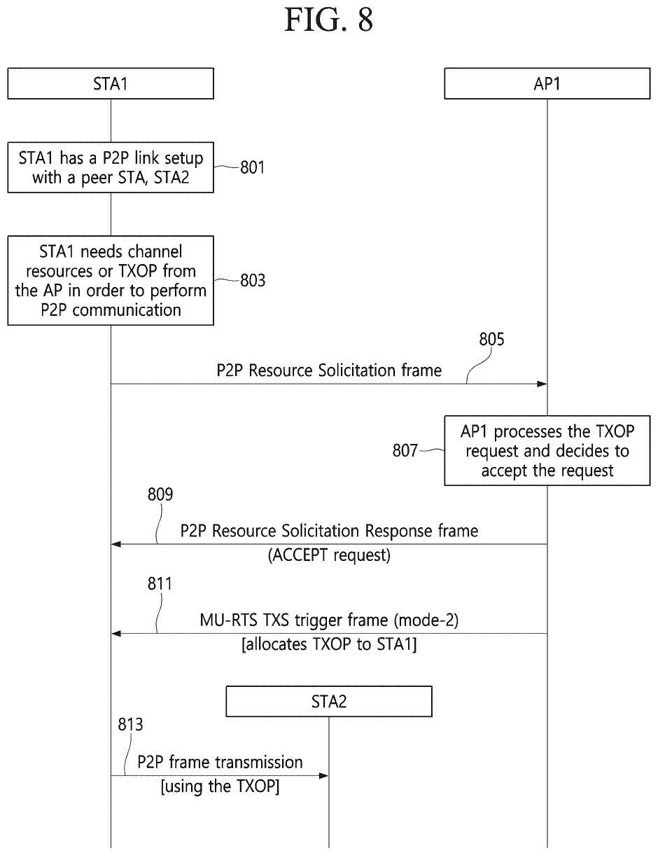

FIG. 8 illustrates a TXOP request-response process for P2P transmission in accordance with an embodiment. Although one or more operations are described or shown in particular sequential order, in other embodiments the operations may be rearranged in a different order, which may include performance of multiple operations in at least partially overlapping time periods. In particular, FIG. 8 illustrates communication between STA1, STA2 and AP. In operation 801, STA1 sets up a P2P link with a peer STA, STA2.

In operation 803, STA1 determines a need for channel resources (e.g., TXOP) from the AP in order to perform P2P communication.

In operation 805, STA1 transmits a P2P Resource Solicitation frame to AP1. In some embodiments, the P2P Resource Solicitation frame can be used to request TXOP from the AP for P2P communications. In some embodiments, the frame can be a Protected EHT Action frame as shown in Table 1 above in accordance with an embodiment. In some embodiments, the P2P may transmit a resource request element that may include a set of parameters that indicates a non-AP STA's resource need for peer-to-peer communication.

In operation 807, AP1 processes the TXOP request and decides to accept the request.

In operation 809, AP1 transmits to STA1 a P2P Resource Solicitation Response frame that indicates acceptance of the request. In certain embodiments, if the AP1 does not accept the request, the response frame may suggest an alternative grant for TXOP with an alternative set of parameters. In some embodiments, the format of the P2P Resource Solicitation Response frame can be the same as or similar to the P2P Resource Solicitation frame.

In operation 811, AP1 transmits to STA1 a MU-RTS TXS trigger frame (mode-2) that allocates TXOP to STA1. AP 1 allocates time with an obtained TXOP to the associated STA1 by transmitting an MU-RTS TXS trigger frame

In operation 813, STA1 begins P2P frame transmission to STA2 using the TXOP.

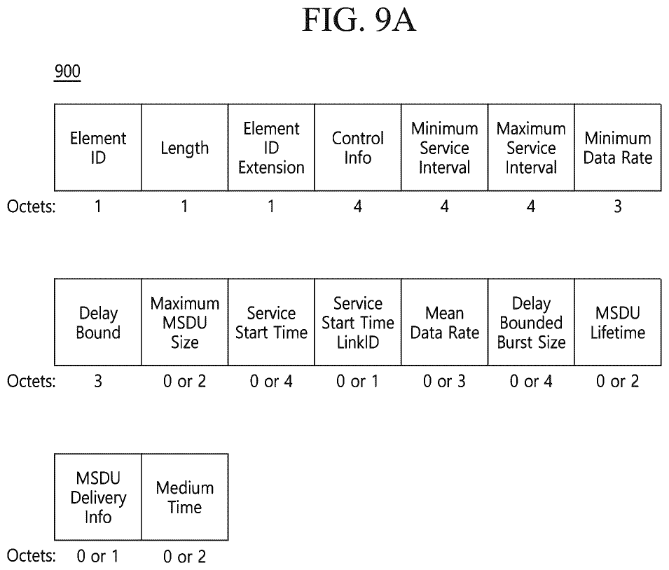

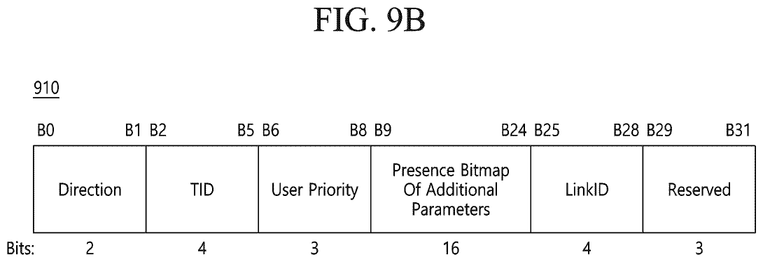

FIG. 9A shows an example of a QoS characteristic element and FIG. 9B shows an example of a Control Info field within the QoS characteristic element in accordance with an embodiment.

Referring to FIG. 9A, the QoS characteristic element 900 includes an Element ID field, a Length field, an Element ID Extension field, a Control field, a Maximum Service Interval field, a Minimum Service Interval field, a Minimum Date Rate field, a Delay Bound field, a Maximum MSDU Size field, a Service Start Time field, a Service Start Time Link ID field, a Mean Date Rate field, a Delay Bounded Burst Size field, a MSDU Lifetime field, a MSDU Delivery Info field, and Medium Time field.

Referring to FIG. 9B, the Control Info field 910 includes a Direction subfield, a TID subfield, a User Priority subfield, a Presence Bitmap of Additional Parameters subfield, a Link ID subfield, and Reserved bits. The Direction subfield indicates the direction of data, such as uplink, downlink, or direct link. The direct link indicates that frames, more specifically MSDUs or A-MSDUs, are sent over a P2P link to a peer STA. The TID subfield indicates a TID value of data frame described by the QoS characteristic element 900. The User Priority subfield indicates the user priority value (0-7) of the data frames described by the QoS characteristic element 900. The Presence Bitmap Of Additional Parameters subfield indicates a bitmap where the i-th entry of the bitmap is set to 1 if the i-th field starting from the Maximum MSDU Size field is present in QoS characteristic element 900. The Link ID subfield contains the link identifier that corresponds to the link for which the direct link transmissions are going to occur.

The Minimum Service Interval field in FIG. 9A may indicate the minimum interval between the start of two consecutive service periods that are allocated to the STA for direct link frame exchanges when the Direction subfield in FIG. 9B is set to the direct link.

The Maximum Service Interval field in FIG. 9A may indicate the maximum interval between the start of two consecutive service periods that are allocated to the STA for direct link frame exchanges when the Direction subfield in FIG. 9B is set to the direct link.

Embodiments in accordance with this disclosure provide mechanisms by which a non-AP STA can request resources (e.g., TXOP) from an AP for P2P communication, which may improve wireless network traffic performance and thereby enhance a multi-device connectivity experience. The TXOP request procedures in accordance with embodiments described herein may be utilized to maintain seamless latency-sensitive traffic flow and improve overall system efficiency.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to:
establish a peer-to-peer (P2P) link with a peer STA;
transmit, to an access point (AP), a request frame that requests a resource from the AP to perform P2P communication with the peer STA;
receive, from the AP, a trigger frame that allocates a transmission opportunity (TXOP) to the STA; and
transmit, to the peer STA, one or more frames via the P2P link within the TXOP.

2. The STA of claim 1, wherein the resource is a TXOP.

3. The STA of claim 1, wherein the processor is further configured to receive a response frame from the AP that accepts the request for resource or provides an alternative resource.

4. The STA of claim 1, wherein the request frame includes at least one or more information from:
a time requested by the STA on the P2P link for P2P communication;
a traffic identifier for P2P communication for the requested time;
a bandwidth for the P2P link for the request time; or
a link identifier that identifies the P2P link.

5. The STA of claim 1, wherein the trigger frame allocates a portion of an obtained TXOP of the AP to the STA.

6. The STA of claim 1, wherein the processor is further configured to receive capabilities information from the AP that indicates a capability to support resource sharing.

7. The STA of claim 1, wherein the request frame includes a buffer status report indicating pending traffic for uplink or the P2P link.

8. The STA of claim 1, wherein the request frame includes a quality of service (QOS) characteristics element that includes a traffic identifier for P2P communication.

9. An access point (AP) in a wireless network, comprising:
a memory; and
a processor coupled to the memory, the processor configured to:
receive, from a station (STA), a request frame that requests a resource from the AP to perform P2P communication with a peer STA; and
transmit, to the STA, a trigger frame that allocates a transmission opportunity (TXOP) to the STA.

10. The AP of claim 9, wherein the resource is a TXOP.

11. The AP of claim 9, wherein the processor is further configured to transmit a response frame to the STA that accepts the request for resource or provides an alternative resource.

12. The AP of claim 9, wherein the request frame includes at least one or more information from:
a time requested by the STA on the P2P link for P2P communication;
a traffic identifier for P2P communication for the requested time;
a bandwidth for the P2P link for the request time; or
a link identifier that identifies the P2P link.

13. The AP of claim 9, wherein the trigger frame allocates a portion of an obtained TXOP of the AP to the STA.

14. The AP of claim 9, wherein the processor is further configured to transmit capabilities information to the STA that indicates a capability to support resource sharing.

15. The AP of claim 9, wherein the request frame includes a buffer status report indicating pending traffic for uplink or the P2P link.

16. The AP of claim 9, wherein the request frame includes a quality of service (QOS) characteristics element that includes a traffic identifier for P2P communication.

17. A computer-implemented method for communicating by a station (STA) in a wireless network, comprising:
establishing a peer-to-peer (P2P) link with a peer STA;
transmitting, to an access point (AP), a request frame that requests a resource from the AP to perform P2P communication with the peer STA;
receiving, from the AP, a trigger frame that allocates a transmission opportunity (TXOP) to the STA; and
transmitting, to the peer STA, one or more frames via the P2P link within the TXOP.

18. The computer-implemented method of claim 17, wherein the resource is a TXOP.

19. The computer-implemented method of claim 17, further comprising receiving a response frame from the AP that accepts the request for resource or provides an alternative resource.

20. The computer-implemented method of claim 17, wherein the request frame includes at least one or more information from:
a time requested by the STA on the P2P link for P2P communication;
a traffic identifier for P2P communication for the requested time;
a bandwidth for the P2P link for the request time; or
a link identifier that identifies the P2P link.
